(19) United States
(12) Patent Application Publication
(10) Pub. No.: US 2007/0277456 A1
(43) Pub. Date: Dec. 6, 2007

(54) Arch assembly for door frame

(76) Inventor: Ronald Prater, Rochester, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/786,245

(22) Filed: Apr. 11, 2007

Related U.S. Application Data
(60) Provisional application No. 60/744,633, filed on Apr. 11, 2006.
(60) Provisional application No. 60/745,474, filed on Apr. 24, 2006.

(51) Int. Cl. E06B 1/04

(52) U.S. Cl. 52/211

(57) ABSTRACT

An assembly includes a pair of side walls and a base wall connected to and extending between the side walls. Each side wall has a triangular configuration defined by a pair side edges and an arcuate edge extending between the side edges. A plurality of first connectors, i.e. openings are defined in each of the side walls and are spaced along the arcuate edge. The base wall presents two sides and a plurality of second connectors, i.e. tabs that extend outwardly from each of the sides. The male connectors are coupled with the female connectors to form the arch assembly.

### FIELD OF THE INVENTION

This non-provisional application claims priority to provisional application Ser. Nos. 60/744,633 filed on Apr. 11, 2006 and 60/745,474 filed on Apr. 24, 2006 and incorporated herewith by reference in its entirety.

### FIELD OF THE INVENTION

The subject invention relates to an arch assembly used in construction of an archway.

### BACKGROUND OF THE INVENTION

Typically, an arch is used in assembly of a wooden support, i.e. door frame at the construction site. The construction of the arches in doorways, or passageways, can be tedious, expensive and time-consuming work and requires a skilled professional, such as, for example, a carpenter.

The art is replete with various designs and methods of forming and assembling the arches used in construction of buildings. Numerous methods of making the arches are taught by the U.S. Pat. No. 3,008,273 to Widin; U.S. Pat. No. 4,400,917 to Massaro et al.; U.S. Pat. No. 4,601,138 to Hampton; U.S. Pat. No. 4,665,666 to Hampton; and U.S. Pat. No. 5,572,834 Lilly.

The U.S. Pat. No. 3,008,273 to Widin, for example, discloses a hollow preformed arch having side walls and a base wall. The base wall is formed concavely arcuate to conform to the shape of side walls. A strip or leg includes a plurality of slits spaced from one another to permit the strip to be curved to conform to the shape of the base wall. A plurality of rivets are required to extend through a multitude of openings defined in the legs of the strip to connect the side walls with the base wall. This design is not practicable and is not cost and/or labor effective because it requires multitude of additional component, i.e. the strip to interconnect the side walls and the base wall, which increases the labor cost.

The U.S. Pat. No. 4,400,917 to Massaro et al. discloses a unitary structure for a full arch-shaped passageway, which is adapted for drywall construction. The unitary structure includes a front panel, a rear panel and an arcuate panel portion therebetween. The unitary structure of the arch-shaped passageway is not compact and flexible in assembly. Damage of at least one of the front panel, the rear panel and the arcuate panel portion requires replacement of the entire arch-shaped passageway.

Alluding to the above, numerous additional attempts had been made in the prior art designs to overcome problems associated with the fabrication of an archway at the construction sites from the combination of contoured plywood, drywall and the intermediate support strips, wherein prefabricated archways made from molded foamed plastics have been used. As such, the U.S. Pat. No. 4,601,138 to Hampton teaches a prefabricated archway formed of molded polyethylene wherein a relatively light weight arch is brought to the location of the project and nailed or otherwise affixed directly to the framing of the adjacent wall. The prefabricated plastic archway is dimensioned to be conformably received in abutting relationship to the adjacent edges of the wall surfaces. The width from one outer surface to the opposing outer surface of the prefabricated archway is equal to the distance between the finished surfaces of the opposing walls. In other words, the arches are dimensioned to form a butt-joint against the existing drywall or wallboard. The prefabricated archway is secured in place by a series of nails applied through the exposed surface of the foam into the studs and headers comprising the support members. Following affixation, conventional taping is applied to the seam between foam and adjacent drywall. In practice, the seam between adjacent drywall and the foam arch has been found to display cracking due in part to the use of dissimilar materials at the seam thereby requiring future repair and maintenance. Also, the subsequent movement of nailheads outwardly and away from the foam archway creates an unsightly appearance requiring further maintenance. The prefabricated archway taught by the U.S. Pat. No. 4,601,138 to Hampton is not practicable and is not cost and/or labor effective because it requires multitude of additional component, i.e. the series of nails to interconnect the components of the archway thereby increasing the labor cost.

The U.S. Pat. No. 4,665,666 to Hampton tried to solve problems associated with the archway taught by the U.S. Pat. No. 4,601,138 to Hampton. During the formation of the archway taught by the U.S. Pat. No. 4,665,666 to Hampton, a mold is aligned with drywall paper which then becomes permanently bonded to the molded archway. The drywall paper strengthens the finished arch by adding a fibrous laminate to its exterior surface so as to reduce cracking. Furthermore, the use of the paper is intended to eliminate the “nail pops” occurring after installation. This modification to the construction of prefabricated archways is required because of the incompatibility of foamed plastic material with the wall-defining materials used in normal construction techniques. While the molded foam prefabricated archways accomplish the goal of eliminating the construction of coarse archway forms at the construction site, the problems arising from the use of a foamed material such as seam parting, cracking, nail popping and limited resistance to applied pressure remain.

The U.S. Pat. No. 5,572,834 Lilly discloses a prefabricated arch form for use in constructing an archway wherein opposing side walls are spaced apart by a curved base wall to permit the side walls to reside between the adjacent wall support and drywall and to fasten drywall. The three elements are fabricated from sheet metal. The side walls are provided with flanges extending along the curved dimension thereof. Each cheek member has two generally orthogonally disposed edges joined at a rounded corner. Each of the edges terminate in a pair of free ends. The free ends are back cut as to provide a generally rounded free end to aid in installation. In the manufacture of the arch preform, first and second cheeks are initially identical planar members. After cutting to the desired shape, the curved edge is subjected to a roller which forms a one quarter (¼″) inch flange therealong. Since the flange is narrow and the bending is being conducted on a sheet metal part, no cuts or relief kerfs need be formed in the flanges. The throat is generally rectangular in shape after cutting. It is then subjected to a bending step to conform to the curvilinear shape of the flanges formed on the cheek members. Next, the throat is affixed to the flanges by a series of spot welds as shown in the end. The use of sheet metal in the construction of the three elements of the arch preform facilitates construction, provides durability to the unitary body and allows flexibility of the cheek members to aid in installation. The arch taught by the U.S. Pat. No. 5,572,834 is not practicable and is not cost and/or labor effective because it requires plurality of redundant operations and components to interconnect the throat with the side walls.

Accordingly, it is a primary objective of the present invention to provide an improved arch assembly adaptable to be shipped in a compact package and to be assembled at the construction site thereby facilitating the construction of arch-shaped passageways.

### SUMMARY OF THE INVENTION

An arch assembly of the present invention is designed for engaging a door frame formed by a pair of vertical beams interconnected by a pair of horizontal beams to define four corners of the door frame. The arch assembly includes a pair of side walls each presenting side edges and an arcuate edge extending between the side edges. A base wall extends between the side walls to define at least one channel therebetween and having a C-shaped configuration for engaging the door frame as the arch assembly is connected to the door frame. A coupling or mechanical connection is defined by the side walls and the base wall for connecting the base wall to the side walls.

Alluding to the above, the coupling includes at least one female connector, i.e. opening defined in each side wall extending along the arcuate edge and at least one male connector, i.e. tab extending from the base wall. Each tab extends through respective opening thereby mechanically interconnecting with one another for forming said arch assembly and preventing relative movement of each side wall with respect to one another. The side walls and the base wall are stamped from a sheet metal. The thickness of the base wall is shorter than the thickness of each of said side walls.

The unique design of the present apparatus provides for a new and improved unitary arch structure adaptable to be shipped in a compact package and to be assembled at the construction site thereby facilitating the construction of arch-shaped passageways.

Another advantage of the present invention is to provide a new and improved method for constructing an arch-shaped passageway which can be accomplished quickly and easily.

Still another object of this invention is to provide a prefabricated cove arch having a body of unitary construction made of a durable, light material.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of an inventive arch assembly connected to a door frame;

FIG. 2 is a perspective view of two arch assemblies spaced from one and the other;

FIG. 3 is a perspective view of two arch assemblies of FIG. 2 connected with one and the other;

FIG. 4 is a fragmental view of a male connector extending through a female connector with the male connector being folded thereby engaging a side panel of the arch assembly;

FIG. 5 is a front view of the side panel having a first plurality of the female connectors formed therein and extending along an arcuate edge of the side panel and a second plurality of the female connectors adjacent the first plurality and shown in phantom;

FIG. 6 is a front view of a base panel of the arch assembly having a plurality of the male connectors extending from peripheral edge of the base panel;

FIG. 7 is a front view of the base panel extending through the side panels of the arch assembly;

FIG. 8 shows a perspective view of an alternative embodiment of the arch assembly;

FIG. 9 shows a fragmental view of the arch assembly of FIG. 8 illustrating the male connector extending through the female connector with the male connector being folded thereby engaging a groove defined in the side panel of the arch assembly;

FIG. 10 shows a front view of a second alternative embodiment of the arch assembly; and

FIG. 11 shows a third alternative embodiment of the arch assembly.

### DETAILED DESCRIPTION OF THE PREFERRED EMBODIMENT

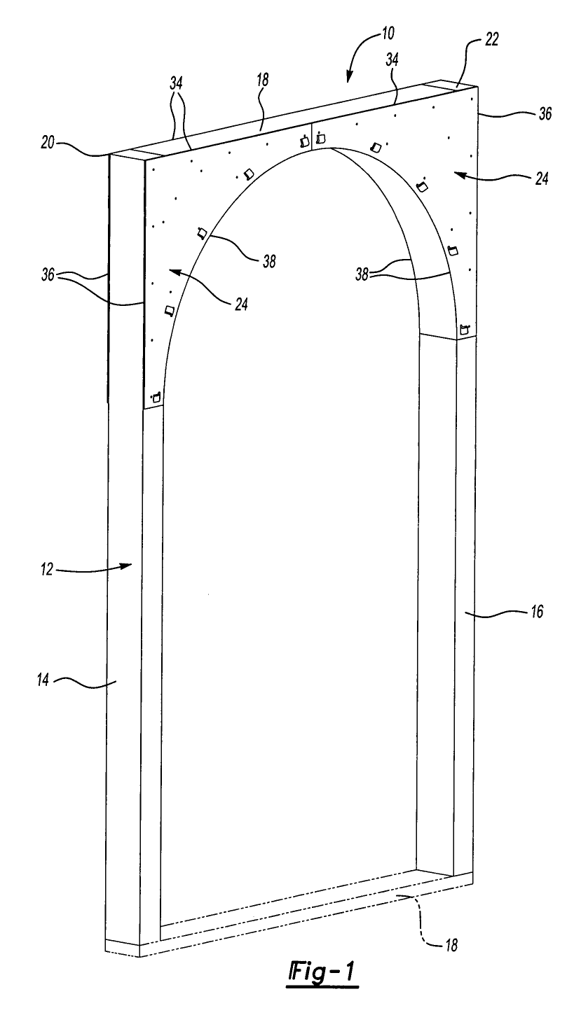

Referring to the FIG. 1, wherein like numerals indicate like or corresponding parts, an arch assembly (the assembly) of the present invention is generally shown at 10. The assembly 10 is designed to form an archway in walls or door frame, generally indicated at 12, formed by a pair of vertical beams 14 and 16 and at least one horizontal beam 18, which as used in construction sites. As appreciated by those skilled in the construction art, the vertical beams 14 and 16 are interconnected by the horizontal beams 18 to define at least two corners 20 and 22 of the door frame 12 each defining the angle of 90 degrees.

The assembly 10 may be formed by a pair of arches with each of them including three components such as a pair of side walls or panels, generally indicated at 24 and 26 and a base wall or panel, generally indicated at 28 having inner and outer surfaces 30 and 32. The base wall 28 is connected to and extends between the side walls 24 and 26. Each side wall 24 and 26 has a triangular configuration defined by a pair of side edges 34 and 36 interconnected one with the other to define an angle of 90 degrees therebetween to complement with the door frame corners 20 and 22.

Alluding to the above, an arcuate or curved edge 38 extends between the side edges 34 and 36. A plurality of first connectors, i.e. female connectors or keyways 40 are defined by slots or openings in each of the side walls 24 and 26. The female connectors 40 are spaced around the arcuate edges 38. Preferable the female connecters 40 may present rectangular or circular configuration.

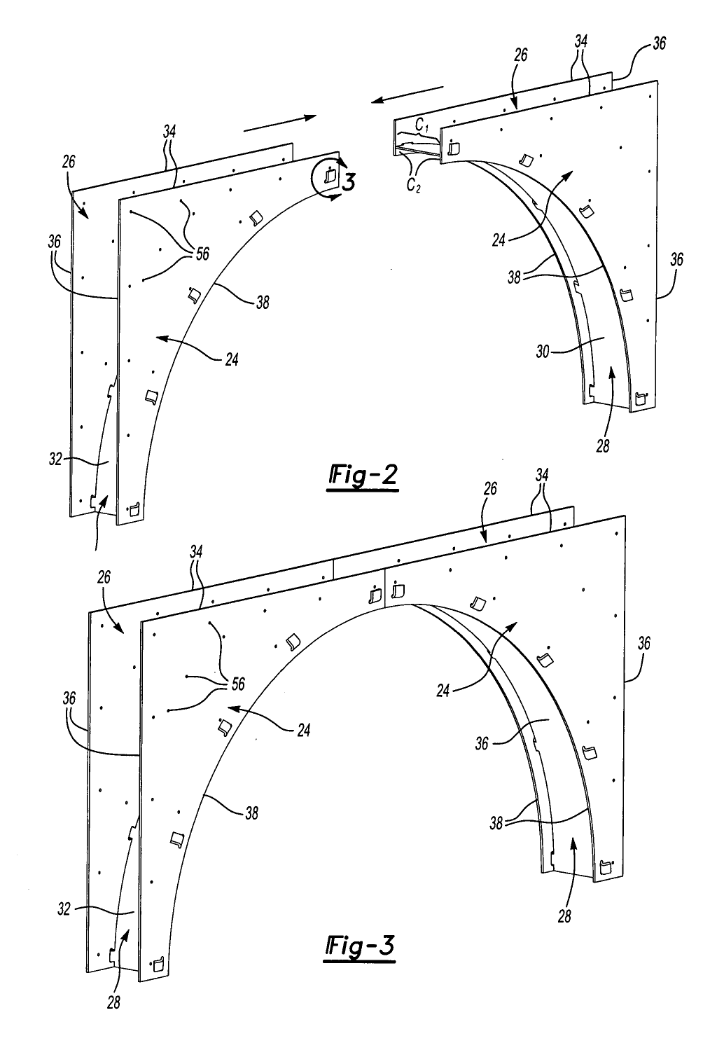

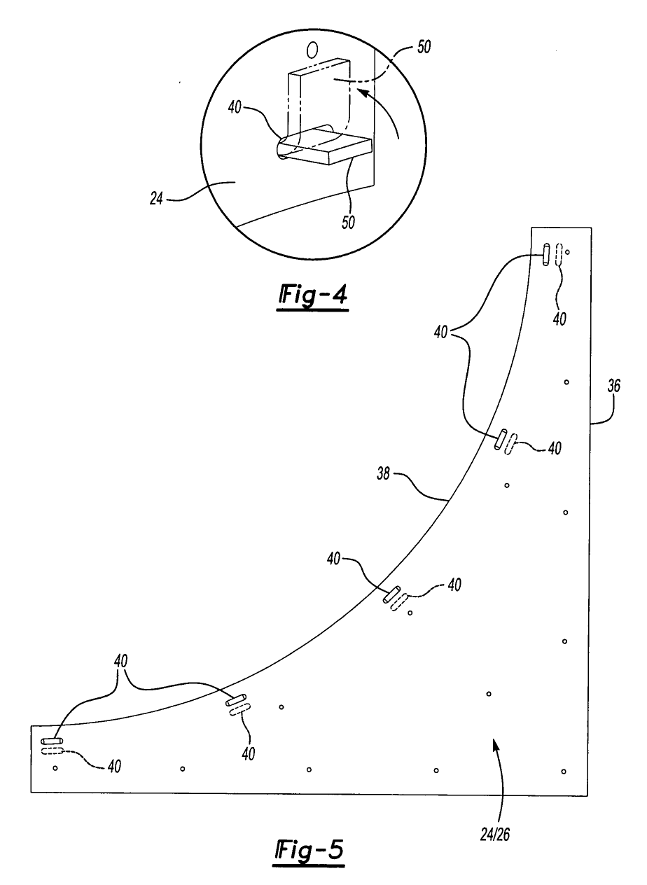

Alternatively, as best shown in FIG. 5, a second plurality of the female connectors 40, shown in phantom, are formed adjacent the first plurality of the female connectors 40 to regulate the depth of one of the channels C1 and C2, as shown in FIG. 2, defined by the base wall 28 and the side walls 24 and 26 to receive a component (not shown) of the door frame 12. The first and second channels C1 and C2 present C-shaped configuration for complementing with the vertical beams 14 and 16 and the horizontal beams 18 of the door frame 12. The rectangularly shaped openings of the female connectors 40 are shown for exemplary purposes and are not intended to limit the scope of the present invention. Alternatively, as best shown in FIG. 9, each female connector 40 may extend to a groove 42 defined in each of the side walls 24 and 26. The groove 42 may be stamped in each side wall 24 and 26 as known to those skilled in the stamping art.

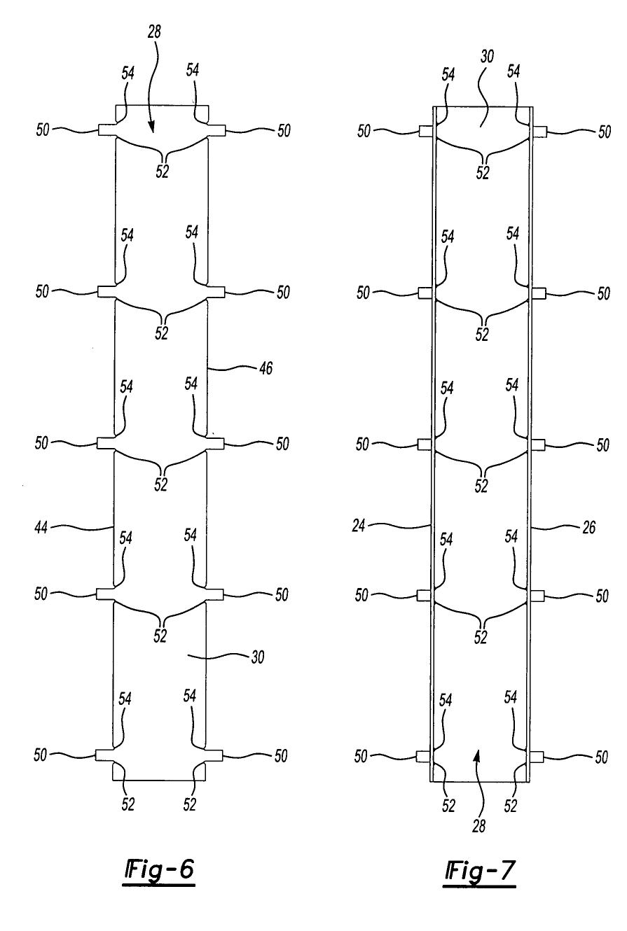

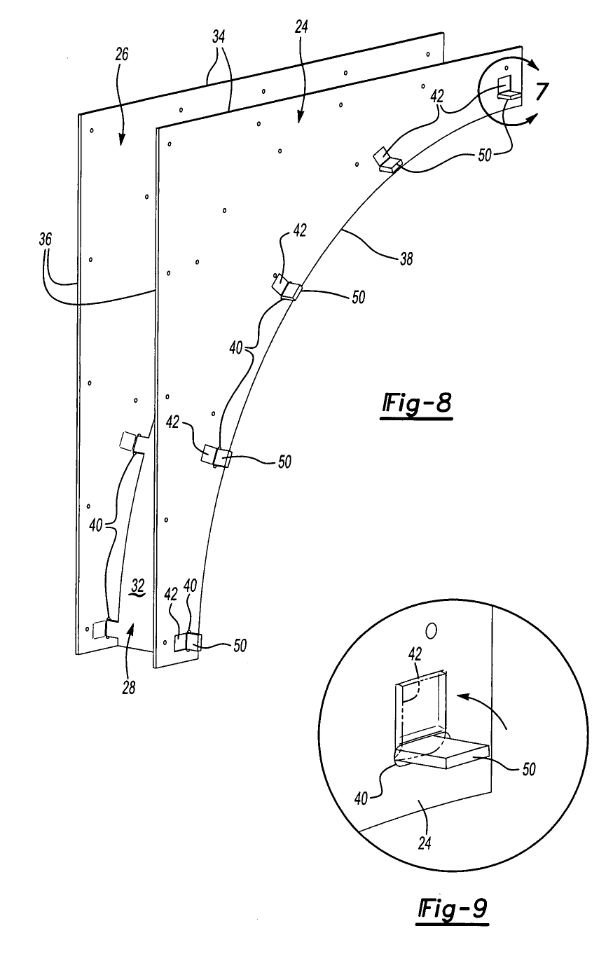

As best shown in FIGS. 6 and 7 the base wall 28 presents two sides 44 and 46 and a plurality of second connectors, i.e. male connectors, such as keys or tabs 50 extending outwardly from each of the sides 44 and 46. The male connectors 50 are integral with and extend from each of the sides 44 and 46 to extend through the complementary female connectors 40 thereby forming the assembly 10. Each male connector 50 is further defined by a tab separated from the sides 44 and 46 by opposing grooves 52 and 54 thereby reducing stress as each tab is bent for preventing relative movement of each side wall 24 and 26 with respect to one another. The male connectors 50 are coupled with the female connectors 40 to form the assembly 10 and preventing relative movement of each side wall 24 and 26 with respect to one another as the male connectors 50 are bent about the respective female connectors 40 thereby engaging the side walls 24 and 26. Each tab has a configuration complementary to the configuration of each of the grooves 42. Each side wall 24 and 26 and the base wall 28 are stamped from a sheet metal. Alternatively the side walls 24 and 26 and the base wall 28 may be formed from a polymeric material, wood, and any other non-metals.

As the assembly 10 is delivered in a compact unit, the male connectors 50 are inserted into the respective female connectors 40 and then folded to engage the side walls 24 and 26 to provide structural integrity of the assembly 10. The thickness of the base wall 28 is shorter than the thickness of each side wall 24 and 26. The assembly 10 is connected to the door frame 12 by a plurality of fasteners, such as, for example nails (not shown) and the like extending through holes 56 formed in the side walls 24 and 26.

The assembly 10 of the present invention has several advantages over the aforementioned prior art designs. The unique design of the assembly 10 provides for a new and improved unitary arch structure adaptable to be shipped in a compact package and to be assembled at the construction site thereby facilitating the construction of arch-shaped passageways. Another advantage of the assembly 10 provides a new and improved method for constructing an arch-shaped passageway which can be accomplished quickly and easily.

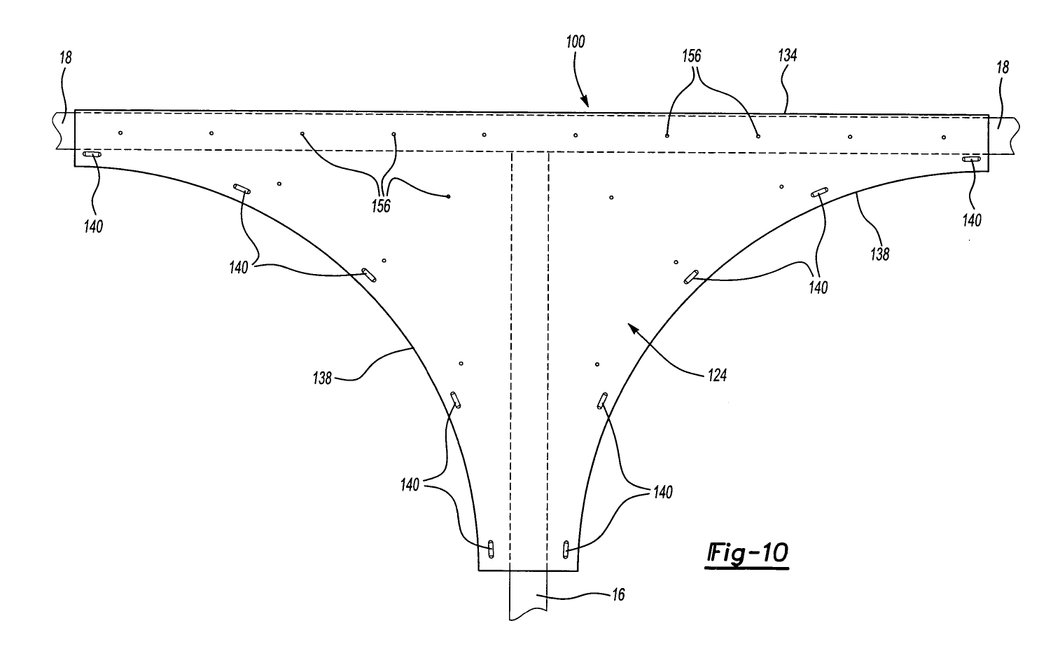

FIG. 10 shows a second alternative embodiment of the present invention, wherein like reference numerals are used to indicate like features with regard to the main embodiment but are offset by 100. The arch 100 is formed by a pair of side walls or panels, only one is shown and is generally indicated at 124 and a base wall or panel, not shown, having inner and outer surfaces. The base wall has a plurality of male connectors, i.e. tabs (not shown). The base wall is connected to and extends between the side walls 124. Each side wall 124 has a triangular configuration defined by a side edge 134 and a pair of arcuate or curved edges 138 extends from the side edge 134. A plurality of female connectors 140 are defined by slots or openings in each of the side walls 124. The female connectors 140 are spaced around the arcuate edges 138 and are designed to receive the male connectors. Preferable the female connecters 140 may present rectangular or circular configuration. The arch 100 is adaptable to engage the door frame having a T-shape wherein the horizontal beam 18 has a vertical beam 16 extending therefrom.

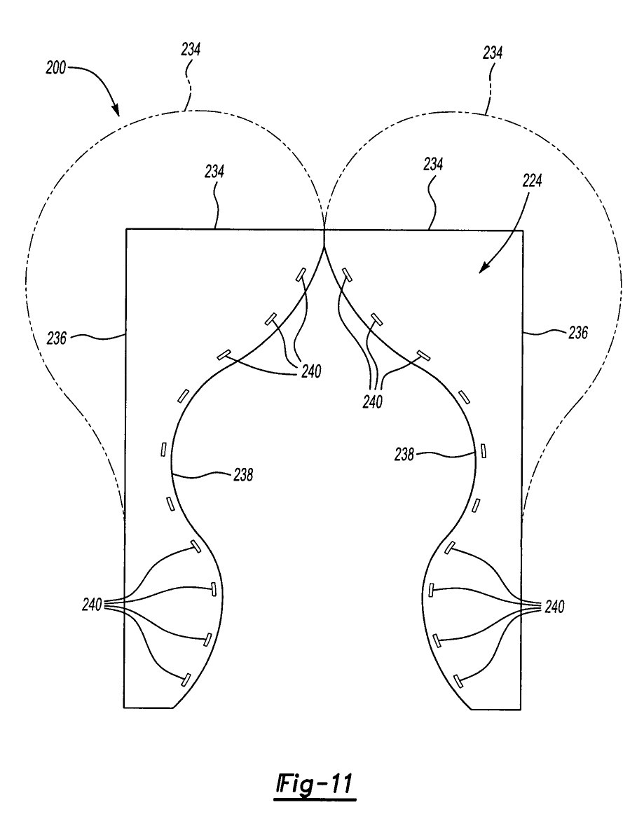

FIG. 11 shows a second alternative embodiment of the present invention, wherein like reference numerals are used to indicate like features with regard to the main embodiment but are offset by 200. The arch assembly, generally shown at 200, is formed by a pair of arches each presenting a pair of side walls or panels, only one is shown and is generally indicated at 224 and a base wall or panel, not shown, having inner and outer surfaces. The base wall has a plurality of male connectors, i.e. tabs (not shown). The base wall is connected to and extends between the side walls 224. Each side wall 224 has a triangular configuration defined by side edges 234 and 236 interconnected one with the other and a curved edge 238 extending between the side edges 234 and 236. The curved edge 238 is defined by at least one concave portion and at least one convex portion to adopt to various designs of door frames. Alternatively, the side edge 234 may be present at least one convex portion, as shown in phantom in FIG. 11 and at least one concave portion (not shown) to be adoptable to various designs of door frames. A plurality of female connectors 240 are defined by slots or openings in each of the side walls 224. The female connectors 240 are spaced around the arcuate edges 238 and are designed to receive the male connectors. Preferable the female connecters 240 may present rectangular or circular configuration.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An arch assembly for a door frame formed by a pair of vertical beams interconnected by a pair of horizontal beams to define four corners of the door frame, said arch assembly comprising:
a pair of side panels each presenting sides;
a base panel extending between said side panels; and
a mechanical connection defined between said side panels and said base panel as said base panel extends through said side panels thereby connecting said side panels and preventing relative movement of said side panels with respect to one another and defining at least one channel therebetween for engaging the door frame as said arch assembly is connected to the door frame.

2. An arch assembly as set forth in claim 1 wherein each of said side panels and said base panel present opposing surfaces and said base panel presents a peripheral edge.

3. An arch assembly as set forth in claim 1 wherein said mechanical connection is further defined by a plurality of keys extending outwardly from said peripheral edge of said base panel and a plurality of keyways formed in each of said side panels for receiving said keys thereby connecting said base panel with said side panels.

4. An arch assembly as set forth in claim 3 wherein each said key is further defined by a tab separated from said peripheral edge by opposing grooves thereby reducing stress as each said tab is bent for preventing relative movement of each side panel with respect to one another.

5. An arch assembly as set forth in claim 3 wherein each said keyway is further defined by a slot thereby forming a first line of said slots extending along said concavely arcuate sides of each said side panels.

6. An arch assembly as set forth in claim 5 including a second line of slots adjacent said first line of slots.

7. An arch assembly as set forth in claim 1 wherein said side panels are further define by two side edges presenting an angle of 90 degrees and a side being concavely arcuate and extending between said two side edges.

8. An arch assembly as set forth in claim 7 wherein said side extending between said two side edges in non-arcuate.

9. An arch assembly as set forth in claim 1 wherein each of said side panels and said base panel present inner surfaces and outer surfaces.

10. An arch assembly as set forth in claim 1 wherein said side panel and said base panel form said at least one channel between said internal surfaces of said base panel and said side panels and another channel defined by said outer surface of said base panel and said inner surfaces of said side panels.

11. An arch assembly as set forth in claim 1 wherein said side panels and said base panels are stamped from a sheet metal.

12. An arch assembly as set forth in claim 1 wherein said side panels and said base panels are stamped from a polymeric material.

13. An arch assembly as said forth in claim 10 wherein said channels present C-shaped configuration for complementing with the vertical beams and the horizontal beams of the door frame.

14. An arch assembly as said forth in claim 1 wherein the thickness of said base wall is shorter than the thickness of each of said side panels.

15. A method of forming an arch assembly for a door frame having a pair of vertical beams interconnected by a pair of horizontal beams to define four corners of the door frame, said method comprising the steps of:
forming a pair of side panels and a base panel; and
mechanically connecting the base panel to the side panels by inserting the base panel through the side panels to connect the side panels with one another thereby defining at least one channel to receive the door frame and to prevent relative movement of the side panels.

16. A method as set forth in claim 15 wherein said step of mechanically connecting the base panel to the side panels is further defined by forming a plurality of keys extending outwardly from the base panel and forming a plurality of keyways formed in each of the side panels to receive the keys thereby connecting the base panel with the side panels.

17. A method as set forth in claim 15 wherein said of forming the key is further defined by forming a tab having opposing grooves defined in the base panel to reduce stress as each tab is bent to preventing relative movement of each side panel with respect to one another.

18. A method as set forth in claim 15 wherein each said step of forming the keyway is further defined by forming a first line of slots each side panel.

19. A method as set forth in claim 15 including the step of forming a second line of slots adjacent the first line of slots.

20. A method as set forth in claim 15 wherein said step of forming the side panels and the base panel is further defined by stamping the base panels and the side panels from a sheet metal.

21. A method as set forth in claim 15 wherein said step of forming the side panels and the base panel is further defined by stamping the base panels and the side panels from a polymeric material.

22. A method as set forth in claim 15 wherein said step of forming the side panels and the base panel is further defined by stamping the base panels and the side panels from a wood.

23. An arch assembly for engaging a door frame formed by a pair of vertical beams interconnected by a pair of horizontal beams to define four corners of the door frame, said arch assembly comprising:
a pair of side panels each presenting side edges and an arcuate edge extending between said side edges;
a base panel extending between said side panels to define at least one channel therebetween for engaging the door frame as said arch assembly is connected to the door frame, and
at least one female connector defined in at least one of said side panels and at least one male connector extending from said base panel to mechanically interconnect said side panels with said base panel thereby forming said arch assembly.

24. A method of forming an arch assembly for a door frame, said method comprising the steps of:
connecting a pair of vertical beams to a pair of horizontal beams to define corners of the door frame;
forming a pair of side panels and a base panel; and
mechanically engaging the base panel with the side panels by inserting the base panel through the side panels to connect the side panels with one another thereby defining at least one channel to receive the door frame and to prevent relative movement of the side panels;
connecting the arch assembly to at least one of the corners of the door frame thereby forming the door frame with at least one corner defining a radius.

25. A method as set forth in claim 24 wherein the step of mechanically engaging the base panel with the side panel is further defined by forming at least one female connector defined in at least one of the side panels and at least one male connector extending from the base panel.
